(19) United States
(12) Patent Application Publication
(10) Pub. No.: US 2024/0294242 A1
(43) Pub. Date: Sep. 5, 2024

(54) Power Unit Used for Swimming Pool Cleaning Machine and Swimming Pool Cleaning Machine

(71) Applicant: Yunda H&H Tech (Tianjin) Co., Ltd., Tianjin (CN)

(72) Inventors: Enyu WEI, Tianjin (CN); Hao XU, Tianjin (CN); Huixin ZHANG, Tianjin (CN); Yu PENG, Tianjin (CN); Yinping YUAN, Tianjin (CN); Xu YANG, Tianjin (CN)

(21) Appl. No.: 18/116,935

(22) Filed: Mar. 3, 2023

(51) Int. Cl. B63H 11/08; B63B 79/15; B63H 11/107; E04H 4/16; G01D 5/14

(52) U.S. Cl. CPC B63H 11/08; B63B 79/15; B63H 11/107; E04H 4/1654; G01D 5/145

(57) ABSTRACT

Disclosed is a power unit used for a swimming pool cleaning machine and the swimming pool cleaning machine. The power unit includes an impeller and a water outlet channel communicated with the impeller. The water outlet channel includes a spiral portion, a linear flowing portion and a water outlet. The inlet of the impeller is communicated with a water, and the outlet of the impeller is communicated with the spiral portion. The linear flowing portion deflects to the outer side of the spiral direction of the spiral portion. A steering stressed portion is formed at the junction of the linear flowing portion and the spiral portion. The steering stressed portion and the spiral portion are respectively located on either sides of the center line of the water outlet. The water outlet direction of the water outlet is opposite to the traveling direction of the swimming pool cleaning machine.

### TECHNICAL FIELD

The present disclosure relates to the technical field of swimming pool cleaning, in particular to a power unit used for a swimming pool cleaning machine and the swimming pool cleaning machine.

### BACKGROUND

Dust, impurities, garbage and the like often enter the swimming pool, which causes the pollution to the environment of the swimming pool and affects the experience of a swimmer, therefore, the swimming pool needs to be cleaned regularly. At present, the swimming pool is mostly cleaned by people, which has problems such as inconvenience in cleaning and waste of labor. There is also an underwater robot on the market for cleaning the ground of the swimming pool, and the private swimming pool or the public swimming pool is cleaned using the underwater robot. The swimming pool cleaning robot can not only save labor, but also clean the swimming pool more thoroughly compared with people. Therefore, cleaning the swimming pool with the swimming pool cleaning robot replacing people is a development trend.

In order to achieve a thorough cleaning effect, it is crucial to design a cleaning route for the swimming pool cleaning robot when it is used to clean the swimming pool. Chinese Patent Application Authorization No. CN 114895691 B discloses a path planning method and device for a swimming pool cleaning robot, wherein a plurality of control units are provided to control the robot to detect the target and to travelling path, and the position and the position to be moved are determined by means of electronic means. According to the solution, by means of path planning, a travelling position of the robot can be accurately controlled to satisfy the purpose of cleaning the swimming pool thoroughly. However, with regard to the arrangement of excessive control units and electronic elements, the costs are significantly increased, which is not conducive to promotion and use. Furthermore, controlling the travelling direction with electronic elements will obviously increase the complexity of a structure, which increase the costs and the failure rate at the same time.

Also, Chinese Patent Application Publication No. CN 114233063 A discloses a swimming pool cleaning robot and a steering method, the swimming pool cleaning robot includes a cleaning robot main body, an angle sensor, a gyro sensor, and an acceleration sensor arranged inside the cleaning robot main body, and further includes a first sonar and a second sonar fixed on one side of the cleaning robot main body in the travelling direction. The solution are provided with precise electronic elements which do not require path planning, and can be directly used in the swimming pool. However, as in the described patent with the Patent Authorization No. CN 114895691 B, a large number of electronic elements are used which increase the costs, and the steering system is also complicated.

In conclusion, in the prior art, for the path control of the swimming pool robot, a manner such as path planning or electronic element identification control is often used, there is no doubt that complex controlling systems and steering systems will be added, and electronic elements with relatively high prices will be applied, which is not conducive to cost control. Therefore, how to better implement travelling of the swimming pool robot on the basis of a simple structure and low costs is a technical problem indeed presented in the art.

### SUMMARY

An objective of the present disclosure is to provide a swimming pool cleaning machine, so as to solve the problem in the prior art described above. By designing a water outlet channel to have a spiral portion and a linear flowing portion, a steering stressed portion can be formed between the spiral portion and the linear flowing portion, using a flowing of the water flow to form an impact on the steering stressed portion, so that the swimming pool cleaning machine can be deflected in an impact direction, and finally forms a zigzag travelling route. The swimming pool cleaning machine of the present disclosure do not require additional electronic components such as steering member and state monitoring member, so that costs can be reduced.

To achieve the above objective, the present disclosure provides the following solutions:

The present disclosure provides a power unit used for a swimming pool cleaning machine. The power unit includes an impeller and a water outlet channel horizontally arranged and communicated with the impeller, wherein the water outlet channel includes a spiral portion, a linear flowing portion and a water outlet which are communicated to one another in sequence, an inlet of the impeller is communicated with water, an outlet of the impeller is communicated with the spiral portion, the linear flowing portion deflects to an outer side of a spiral direction of the spiral portion, a steering stressed portion is formed at a junction of the linear flowing portion and the spiral portion, the steering stressed portion and the spiral portion are respectively located on either sides of a center line of the water outlet, and a water outlet direction of the water outlet is opposite to a traveling direction of the swimming pool cleaning machine.

Preferably, a flow distribution plate is arranged inside the linear flowing portion in a direction parallel to an extending direction of the linear flowing portion, the water outlet is of a flared structure, the water outlet is hinged to a swing-out baffle at an upper part of the swing-out baffle, and the swing-out baffle seals the water outlet by its own weight when it is not subjected to an impact of a water flow.

The present disclosure also provides a swimming pool cleaning machine. The swimming pool cleaning machine includes a housing, a travelling device arranged at a bottom of the housing and a filter screen arranged inside the housing, the filter screen divides a space inside the housing into a water inlet chamber and a water outlet chamber, the water inlet chamber is communicated with water inlets in the bottom of the housing, the water outlet chamber is communicated with two groups of above mentioned power units with opposite driving directions, the inlet of the impeller is communicated with water inside the water outlet chamber, the water outlet is in communication with an outside of the housing and a water outlet direction of the water outlet is opposite to a traveling direction of the traveling device; one of the water inlets is located on a right side of the travelling device with respect to the traveling direction of the travelling device, and the steering stressed portion is subjected to a counterclockwise deflecting force, or one of the water inlets is located on a left side of the travelling device with respect to the traveling direction of the travelling device, and the steering stressed portion is subjected to a clockwise deflecting force.

Preferably, the travelling device includes travelling wheels, each of the travelling wheels is rotatably installed on a wheel frame via a wheel shaft, a top of the wheel frame is provided with a positioning block and an annular groove, a positioning groove is arranged at a position on the housing corresponding to the positioning block, a first buckle is arranged corresponding to the annular groove, and the first buckle is clamped into the annular groove to fix the wheel frame; the wheel frame is provided with a large through-hole and a small through-hole for being penetrated by the wheel frame, the wheel shaft includes a small diameter portion and a large diameter portion connected to each other, the small diameter portion has a diameter smaller than that of the small through-hole, and the large diameter portion has a diameter between the diameter of the small through-hole and a diameter of the large through-hole.

Preferably, the travelling wheels are disposed on an outer surface of a bottom of the housing in a cross-shaped arrangement, and a gravity center of one of the travelling wheels at a front side and a gravity center of one of the travelling wheels at a rear side are provided in an offset arrangement, and are offset towards respective water inlets.

Preferably, the housing is provided with wall contact sensing assemblies, each of the wall contact sensing assemblies includes a water wheel rotatably arranged on the housing and a Hall sensing probe fixedly arranged on the housing, the water wheel includes a rotation portion and blades radially connected on the rotation portion, an end of the rotation portion is connected with a rotation disk, a plurality of magnets are distributed and installed on the rotation disk along a circumferential direction, when parts, located in a wall contact detection water channel, of the blades are impacted by a water flow, the magnets rotates relative to the Hall sensing probe, and when the blades are not acted upon by the water flow, the magnets are stationary relative to the Hall sensing probe.

Preferably, the swimming pool cleaning machine includes arc-shaped grooves, wherein a central shaft is rotatably erected on two side walls of each of the arc-shaped grooves, the rotation portion is rotatably sleeved on the central shaft, two ends of the central shaft are respectively arranged with two shaft shoulders, the two shaft shoulders are rotatably clamped on the two side walls of a corresponding one of the arc-shaped grooves, and a distance between the two shaft shoulders is greater than an axial width of the water wheel.

Preferably, a sleeve is rotatably arranged in the rotation portion, and the central shaft is rotatably arranged in the sleeve.

Preferably, each of the water inlets is hinged to a swing-in baffle, the swing-in baffle is connected to a limiting portion, a swing angle of the swing-in baffle is limited by the limiting portion to less than 90 degrees, and the swing-in baffle seals a corresponding one of the water inlets by its own weight when it is not subjected to an impact of a water flow.

Preferably, a top of the housing is provided with a U-shaped handle, two supporting legs of the U-shaped handle are hinged on the housing, and a top of the U-shaped handle is hollow and is sealed by a handle cover.

Compared with the prior art, the present disclosure has the following technical effects.

Firstly, by designing a water outlet channel to have a spiral portion and a linear flowing portion, the steering stressed portion can be formed between the spiral portion and the linear flowing portion. While the water inside a swimming pool is extracted and filtered, an impact on the steering stressed portion is formed by using the flowing of the water flow, so that the swimming pool cleaning machine can be deflected in the impact direction and finally form a zigzag traveling route. Without additional electronic components such as steering and state monitoring components, the complexity degree of the structure can be reduced, so that the cost can be reduced.

Secondly, the water inlets are differentiated according to the arrangement positions of different water inlets, the water inlet provided on the right side of the travelling device is matched with a counterclockwise deflection, and the water inlet provided on the left side of the travelling device is matched with a clockwise deflection, the water inlet can be located at the outer diameter side of the deflection arc; in addition, a scraper is further provided on the rear side of the water inlet, and the dirt on the ground of the swimming pool can be better cleaned by using the scraper and the relationship between the water inlet and the travelling direction.

Thirdly, the travelling wheels are disposed on an outer surface of a bottom of the housing in a cross-shaped arrangement, a gravity center of one of the travelling wheels at a front side and a gravity center of one of the travelling wheels at a rear side are provided in an offset arrangement, and are offset towards respective water inlets. When the swimming pool cleaning machine travels, because the resistance on one side where the water inlet is located is relatively large, one side where the water inlet is located can be better supported. Further, under the action of the deflecting force acting upon the steering stressed portion, the deflection resistance brought by the travelling wheels can be reduced, the deflection of the swimming pool cleaning machine is better realized, and the micro-arc-shaped travelling of the swimming pool cleaning machine is kept.

Fourthly, the rotation portion of the water wheel is rotatably connected with the sleeve to form one-stage rotational connection, the central shaft is rotatably connected with the sleeve to form one-stage rotational connection, the central shaft is rotatably connected with the arc-shaped groove to form one-stage rotational connection, so that three-stage rotational connection can be formed. When one of the one-stage rotational connections is influenced by debris and then cannot rotate, the other of the one-stage rotational connections can be used to avoid the rotation of the water wheel from being stuck and ensure the stable operation of the wall contact sensing assembly.

Fifthly, the distance between the two shaft shoulders of the central shaft is greater than the axial width of the water wheel, so that when the arc-shaped groove is deformed and contracted, the two side walls of the arc-shaped groove can be supported, thereby avoiding the influence of the two side walls of the arc-shaped groove on the rotation of the water wheel, and further improving the operation reliability of the wall contact sensing assembly.

Sixthly, the water inlet is blocked by the swing-in baffle. When water is pumped, the water can smoothly enter the water inlet chamber through the water inlet, and the swing angle of the swing-in baffle can be limited by the limiting portion, thereby avoiding the problem that the water inlet cannot be sealed by its own weight due to the excessive swing angle thereof, and dirt which have been filtered in the water inlet chamber are discharged again, so that the smooth progress of the cleaning process can be ensured.

Seventhly, the top of the housing is provided with the U-shaped handle, and the top of the U-shaped handle is provided with a hollow portion. The top of the U-shaped handle can naturally float up to a vertical state. When the swimming pool cleaning machine needs to be taken out for charging or maintenance, the U-shaped handle can be clamped by tools. The swimming pool cleaning machine at the bottom of the swimming pool is convenient to be grabbed, so that the convenience in operation is improved.

### BRIEF DESCRIPTION OF THE DRAWINGS

To more clearly illustrate technical solution in the embodiments of the present disclosure or in the prior art, the following briefly introduces the accompanying drawings to be used in the embodiments. Apparently, the accompanying drawings in the following description show merely some embodiments of the present disclosure, and those skilled in the art may still derive other drawings from these accompanying drawings without creative efforts.

FIG. 1 is a front structural schematic diagram of the present disclosure;

FIG. 2 is a bottom structural schematic diagram of the present disclosure;

FIG. 3 is a sectional view of FIG. 1 showing a water outlet channel;

FIG. 4 is a top view of FIG. 3;

FIG. 5 is a structural schematic diagram of the present disclosure after an upper housing is removed;

FIG. 6 is a structural schematic diagram of FIG. 5 after a control cabin cover is removed;

FIG. 7 is an exploded structural schematic diagram of a U-shaped handle in the present disclosure;

FIG. 8 is an internal structural schematic diagram of an upper housing in the present disclosure;

FIG. 9 is a structural schematic diagram of an integrated grille plate in the present disclosure;

FIG. 10 is a structural schematic diagram of an arc-shaped groove in the present disclosure;

FIG. 11 is a partial structural schematic diagram of a wall contact sensing assembly in the present disclosure;

FIG. 12 is an exploded structural schematic diagram of a water wheel in the present disclosure;

FIG. 13 is another structural schematic diagram of a water wheel in the present disclosure;

FIG. 14 is a structural schematic diagram of a travelling device in the present disclosure;

FIG. 15 is a cross-sectional structural schematic diagram of FIG. 14;

FIG. 16 is a schematic diagram of an internal structure of a lower housing in the present disclosure;

FIG. 17 is a structural schematic diagram of an swing-in baffle in the present disclosure;

FIG. 18 is a structural schematic diagram of a second counterweight block in the present disclosure; and

FIG. 19 is a structural schematic diagram of an impeller in the present disclosure.

Reference numbers: 1, upper housing; 11, second buckle; 12, indicating light; 13, switch; 14, U-shaped handle; 141, handle cover; 15, water outlet channel; 151, flow distribution plate; 152, spiral portion; 153, linear flowing portion; 154, steering stressed portion; 16, wall contact detection water channel; 2, lower housing; 21, water inlet; 22, scraper; 23, charging port; 24, swing-in baffle; 241, limiting portion; 25, first buckle; 26, positioning groove; 3, travelling device; 31, wheel shaft; 32, travelling wheel; 33, wheel frame; 331, annular groove; 332, positioning block; 4, integrated grille plate; 41, protecting grille; 42, water outlet; 43, division plate; 44, swing-out baffle; 5, impeller; 51, inlet; 52, outlet; 6, wall contact sensing assembly; 61, arc-shaped groove; 62, water wheel; 621, blade; 622, rotation portion; 623, rotation disk; 63, central shaft; 64, sleeve; 7, filter screen; 8, control cabin; 81, battery; 82, motor; 83, Hall sensing probe; 84, liquid level probe; 85, control cabin cover; and 9, second counterweight block.

### DETAILED DESCRIPTION OF THE EMBODIMENTS

The following clearly and completely describes the technical scheme in the embodiments of the present disclosure with reference to the accompanying figures in the embodiments of the present disclosure. Apparently, the described embodiments are merely a part rather than all of the embodiments of the present disclosure. Based on the embodiment in the present disclosure, all other embodiments obtained by persons of ordinary skill in the art under the premise of without contributing creative efforts belong to the scope protected by the present disclosure.

The objective of the present disclosure is to provide a power unit used for a swimming pool cleaning machine and the swimming pool cleaning machine so as to solve the problems in the prior art. A water outlet channel is provided with a spiral portion and a linear flowing portion, a steering stressed portion can be formed between the spiral portion and the linear flowing portion, and an impact on the steering stressed portion is formed by using a flowing of the water flow, so that the swimming pool cleaning machine can be deflected in the impact direction and finally form a zigzag traveling route. Without additional electronic components such as steering components and state monitoring components, the cost can be reduced.

To make the foregoing objective, features and advantages of the present disclosure clearer and more comprehensible, the present disclosure is further described in detail below with reference to the accompanying figures and specific embodiments.

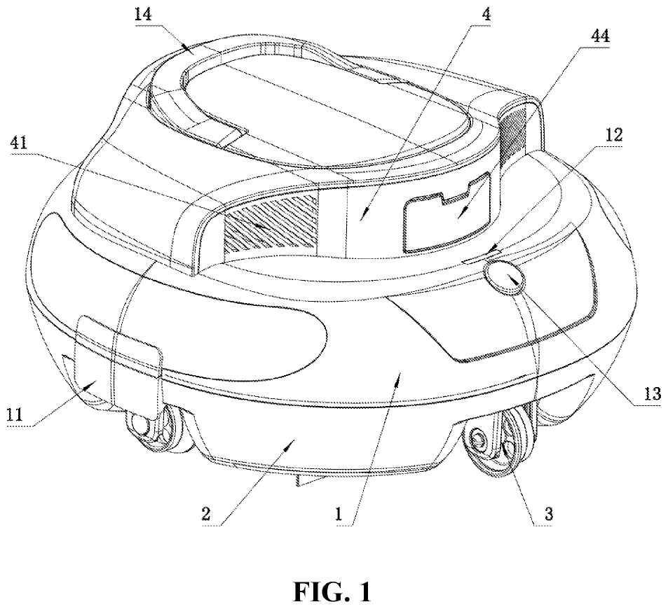

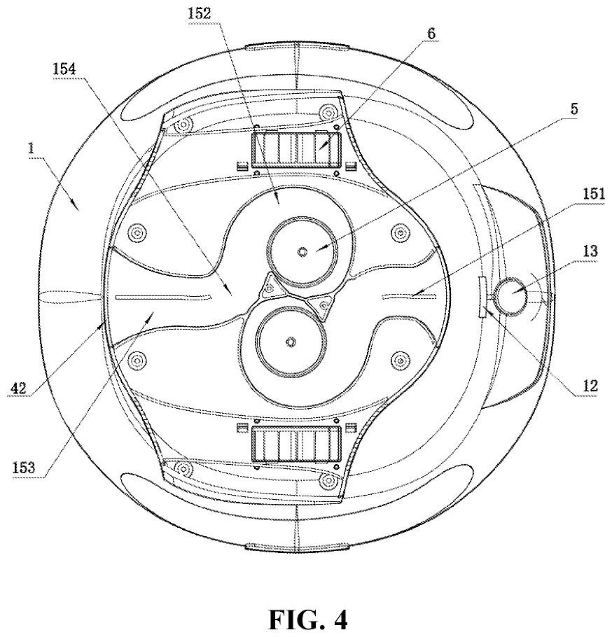

As shown in FIGS. 1-4, the present disclosure provides a power unit used for a swimming pool cleaning machine, which can be installed on the swimming pool cleaning machine to drive the swimming pool cleaning machine to travel, and can be an independent power unit, namely, an impeller 5 is not a power driving structure for filtering of the swimming pool cleaning machine; or also can be a non-independent power unit, namely, the impeller 5 is shared with the power driving structure for filtering of the swimming pool cleaning machine. The power unit includes an impeller 5 and a water outlet channel 15. The inlet 51 of the impeller 5 is connected with the outlet water chamber of the swimming pool cleaning machine or directly connected with a water outside the swimming pool cleaning machine. The outlet 52 of the impeller 5 is connected with the water outlet channel 15, the water can flow into the water outlet channel 15 under the action of the impeller 5. The water outlet channel 15 includes a spiral portion 152 and a linear flowing portion 153 which are communicated to one another in sequence. The linear flowing portion 153 is communicated with a water outlet 42. The water flowing into the water outlet channel 15 is discharged out of the swimming pool cleaning machine through the water outlet 42. Referring to FIG. 4, the linear flowing portion 153 deflects outward in a spiral direction of the spiral portion 152. A steering stressed portion 154 is formed at the junction of the linear flowing portion 153 and the spiral portion 152. The water flow flowing out of the spiral portion 152 may impact the steering stressed portion 154 and then be deflected forcibly to flow to the linear flowing portion 153. Therefore, a force in the spiral direction of the spiral portion 152 is applied to the steering stressed portion 154, and the force can drive the swimming pool cleaning machine to deflect to some extent. The water outlet 42 is connected to outside of the housing and faces towards a direction that is opposite to the travelling direction of the travelling device 3. Thus, the swimming pool cleaning machine can be driven to travel by the reaction force of the water flow discharged from the water outlet 42. Since the swimming pool cleaning machine is subjected to both the steering thrust force of the steering stressed portion 154 and the travelling thrust force of the water flow discharged from the water outlet 42, the swimming pool cleaning machine will travels to the left front or right front, and different travelling directions can be controlled by controlling the operations of different power units, and thus a zigzag travelling route covering a bottom surface area of the swimming pool can be formed in the swimming pool, the swimming pool can be cleaned relatively thoroughly. In conclusion, in the present disclosure, by designing the water outlet channel 15 to have the spiral portion 152 and the linear flowing portion 153, the steering stressed portion 154 can be formed between the spiral portion 152 and the linear flowing portion 153, and the impact of the steering stressed portion 154 is generated by the flowing of the water flow while the water in the swimming pool is extracted and filtered, so that the swimming pool cleaning machine may be deflected in the impact direction, and the zigzag travelling route is finally formed without additional electronic elements for such as steering and state monitoring, thus, the complexity of the structure is reduced, and the manufacturing cost is reduced too.

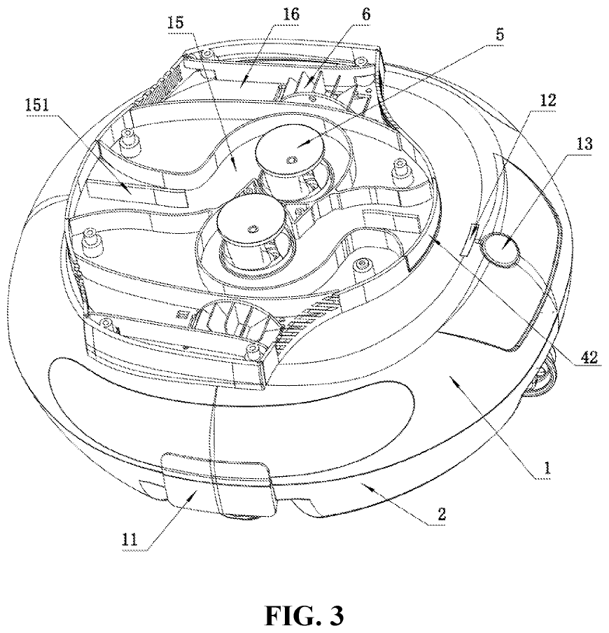

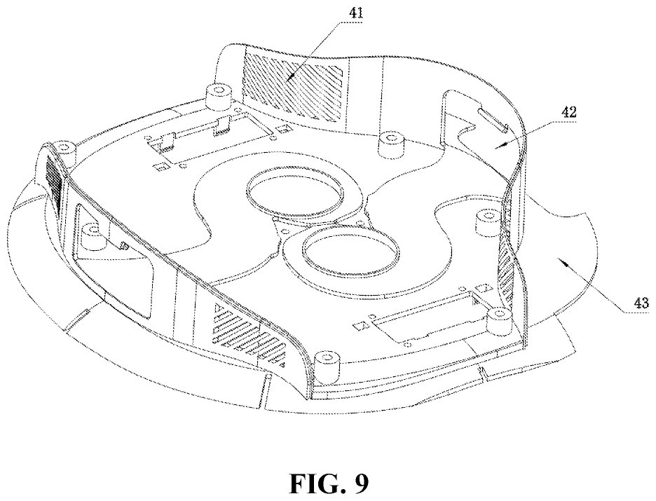

As shown in FIG. 3 and FIG. 4, a flow distribution plate 151 is provided in each of the linear flowing portion 153 in a direction parallel to extending direction of the linear flowing portion 153, and the flow distribution plate 151 can divide the water flow flowing toward outside to generate a turbulent flow and also can form an effective support structure, so as to keep the water outlet channel 15 smooth and structurally stable. The water outlet 42 has a flared structure to facilitate the diffusion of the water flow. Referring to FIG. 1 and FIG. 9, a swing-out baffle 44 is hinged to the water outlet 42 at an upper part of the swing-out baffle 44. Since the water outlets 42 arranged in the opposite direction does not work at the same time, when the water outlet 42 is in a working state, the swing-out baffle 44 is impinged by the water flow, so that the water outlet 42 is accessible, and when the water outlet 42 is not in the working state, the water outlet 42 is closed by the self-weight of the swing-out baffle 44 as there in not the impact of the water flow.

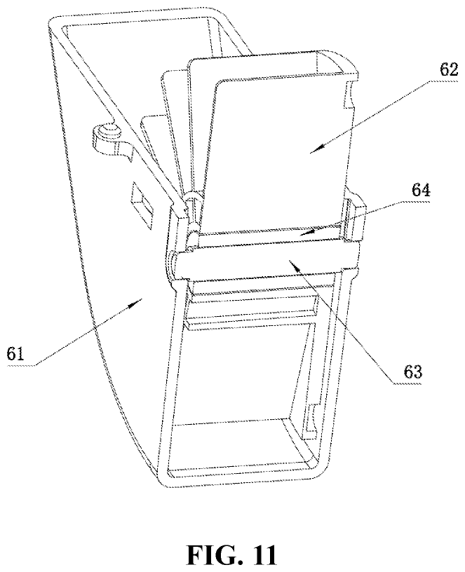

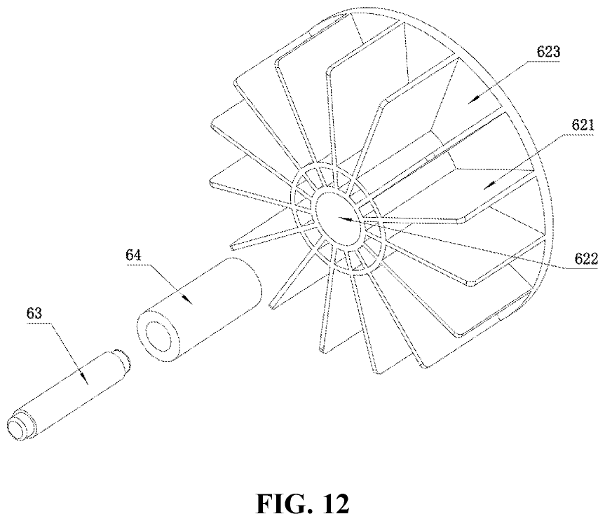

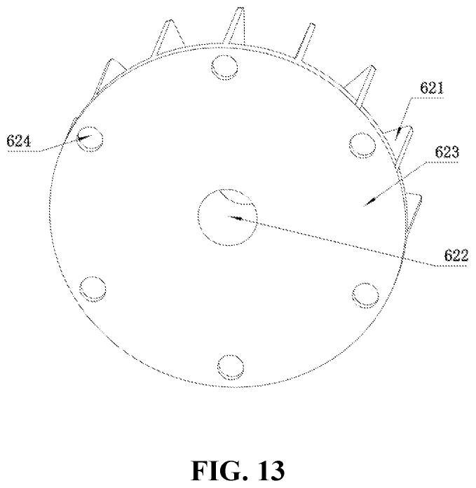

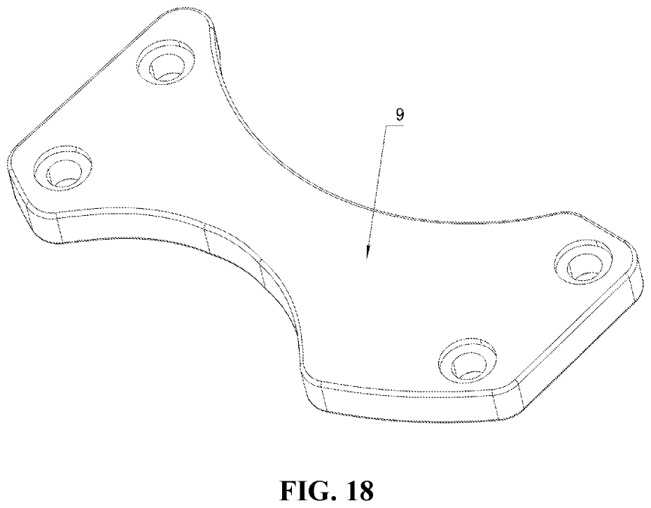

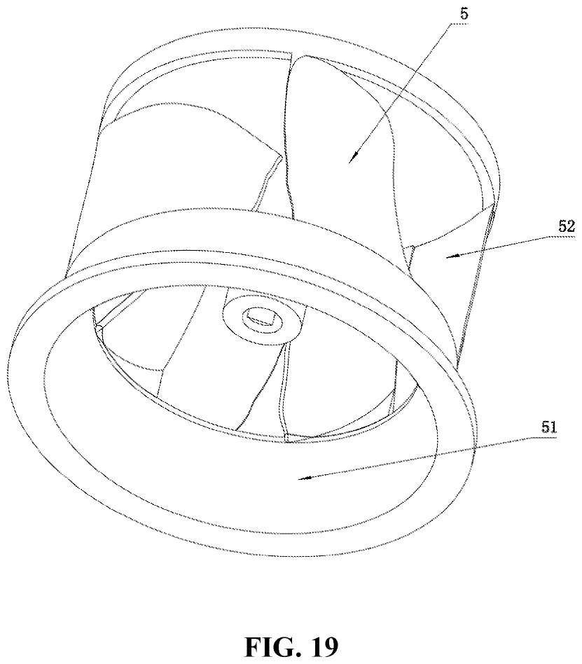

As shown in FIGS. 1-19, the housing can be provided in a separated arrangement, which facilitates disassembly, installation and connection, and facilitates installation of internal components and cleaning of dirt impurities after being disassembled. For example, the housing may include an upper housing 1 and a lower housing 2, wherein the upper housing 1 and the lower housing 2 are clamped via second buckles 11. During disassembly of the housing, the upper housing 1 and the lower housing 2 can be disconnected by turning the second buckles 11 outwards which make both the mounting and disassembling convenient. The travelling device 3 is a rotatable ground travelling structure with a roller or a roller and the like. The filter screen 7 divides a space inside the housing into a water inlet chamber and a water outlet chamber, wherein the water inlet chamber is in communication with water inlets 21 at the bottom of the housing, the water outlet chamber is in communication with water outlets 42. Under the action of impeller 5, water in a swimming pool enters the water inlet chamber through the water inlet 21, and then the impurities stay in the water inlet chamber under the action of the filter screen 7, and the water passing through the filter screen 7 enters the water outlet chamber. Two groups of power units with opposite driving directions are arranged in the water outlet chamber, and when the different power units operate, the swimming pool cleaning machine can be driven to move in opposite directions.

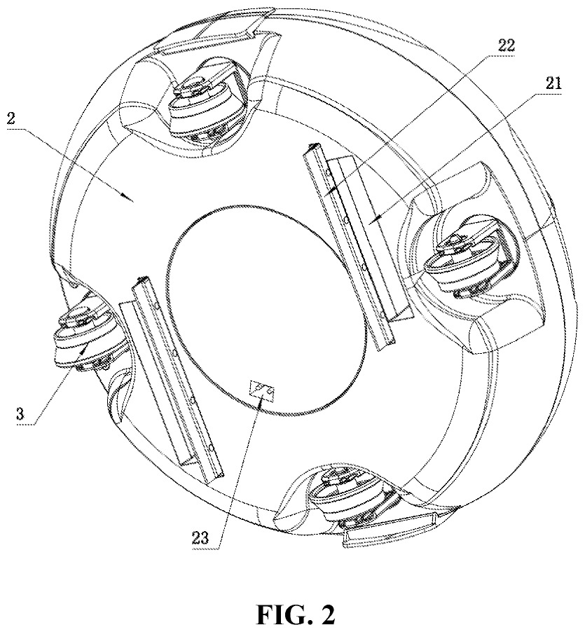

In conjunction with what is shown in FIG. 2, one of the water inlets 21 is located on a right side of the travelling device 3 with respect to the travelling direction of the travelling device, and in conjunction with what is shown in FIG. 4, the steering stressed portion 154 is subjected to a counterclockwise deflecting force, and at this moment, the swimming pool cleaning machine travels to the left and the front. Alternatively, another form is also provided, which is not shown in the figures, that is, the water inlet 21 is located on a left side the travelling device 3 with respect to the travelling direction of the travelling device, the steering stressed portion 154 is subjected to a clockwise deflecting force, and at this moment, the swimming pool cleaning machine travels to the right and the front. By matching the water inlet 21 provided on the right side of the travelling device with a counterclockwise deflection, and matching the water inlet 21 provided on the left side of the travelling device with a clockwise deflection (not shown in the figures), the water inlet 21 can be located at the outer diameter side of the deflection arc; in addition, a scraper 22 can be further provided on the rear side of the water inlet 21, and the dirt on the ground of the swimming pool can be better cleaned by using the scraper 22 and the relationship between the water inlet 21 and the travelling direction. In addition, the water inlet 21 can be in the form of an elongated opening. The scraper 22 is parallel to the length direction of the water inlet 21, and the length of the scraper 22 is slightly greater than the length of the water inlet 21, so that a larger cleaning area can be covered, and dirt can be better collected and pumped by the water inlet 21.

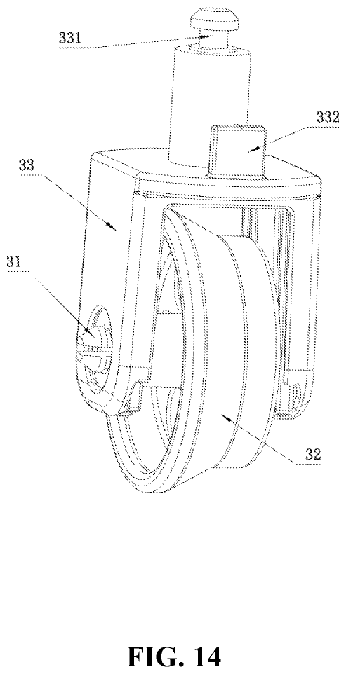

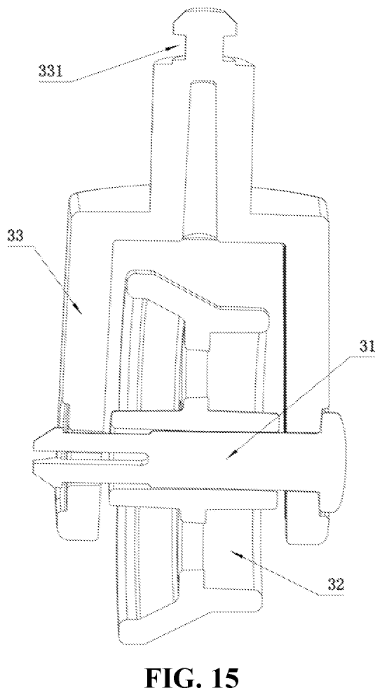

As shown in FIG. 1, FIG. 2, FIG. 14 and FIG. 15, the travelling device 3 includes travelling wheels 32, and each of the travelling wheels 32 is rotatably mounted on a wheel frame 33 via a wheel shaft 31. The top of the wheel frame 33 is provided with a positioning block 332 and an annular groove 331, and the housing (the lower housing 2) is provided with a positioning groove 26 corresponding to the positioning block 332. A first buckle 25 corresponding to the annular groove 331 is provided, and after the positioning block 332 is clamped into the positioning groove 26, the first buckle 25 can be clamped into the annular groove 331 to fix the wheel frame 33. Two positioning grooves 26 are provided at symmetrical positions on the lower housing 2, which make the mounting orientations of the travelling device 3 replaceable to facilitating the mounting based on the requirement of different direction of the travelling device 3. A U-shaped groove is provided at a position where the travelling wheel 32 is mounted on the wheel frame 33, and two supporting arms of the U-shaped groove are provided with a large through-hole and a small through-hole respectively for being penetrated by the wheel shaft 31, the wheel shaft 31 is arranged to include a small diameter portion and a large diameter portion which are connected to each other, wherein the small diameter portion is smaller in diameter than the small through-hole, namely, the small diameter portion can smoothly pass through the small through-hole, and the large diameter portion has a diameter between the diameter of the small through-hole and the diameter of the large through-hole, namely, the large diameter portion can smoothly pass through the large through-hole but cannot pass through the small through-hole. Therefore, when mounting the wheel shaft 31, the mounting can only be performed in one manner, so as to ensure the unification when mounting different travelling devices 3.

The small diameter portion may include two elastic strips arranged opposite to each other and two clamping heads connected to free ends of the two elastic strips respectively, and a deformation seam is provided between the two elastic strips. When the two elastic strips are deformed close to each other, the overall diameter of the two clamping heads can be reduced, so that the overall diameter of the two clamping heads are less than that of the small through-hole, so that it is convenient for the clamping head to pass through the small through-hole, and the clamping heads passing through the small through-hole are restored to a free state, and the overall diameter of the two clamping heads in the free state are greater than that of the small through-hole, thus, the wheel shaft 31 can be limited, and the wheel shaft 31 can be prevented from detachment along the original path. The large diameter portion may be a cross-shaped shaft. One end of the cross-shaped shaft is connected to the small diameter portion, and the other end of the cross-shaped shaft is connected to a limiting plate. The clamping heads and the limiting plate are separately located at two sides of the wheel frame 33 respectively, which limits the wheel shaft 31 on the wheel frame 33.

In conjunction with what is shown in FIG. 2, the travelling wheels 32 are disposed on an outer surface of a bottom of the housing (the lower housing 2) in a cross-shaped arrangement, one of the travelling wheels 32 on the left side and one of the travelling wheel 32 on the right side are symmetrically arranged, a gravity center of one of the travelling wheels 32 on the front side and a gravity center of one of the travelling wheels 32 on the rear side are provided in an offset arrangement and are offset towards respective water inlets. When the swimming pool cleaning machine travels, the swimming pool cleaning machine is subjected to the deflecting force of the steering stressed portion 154, and the resistance at the side where the water inlet 21 is located is relatively large according to the travelling manner of the swimming pool cleaning machine described above and the cleaning action manner of the water inlet 21 and the scraper 22, and by means of the center offset arrangement, the side where the water inlet 21 is located can be better supported, further, under the effect of the deflecting force acting upon the steering stressed portion 154, the deflecting resistance caused by the travelling wheels 32 can be reduced for better realizing deflection of the swimming pool cleaning machine. Furthermore, the position of the gravity centre offset of the travelling wheel 32 provided in a offset arrangement can be combination with the force conditions of the steering stressed portion 154 for coupling analysis to get a rational design. By means of the rational design, the micro arc-shaped travelling of the swimming pool cleaning machine can be guaranteed, and the coverage effect for cleaning the swimming pool is improved, so as to realize blind corner cleaning.

As shown in FIGS. 3-6 and FIGS. 10-13, the housing (upper housing 1) is provided with wall contact sensing assemblies 6. Each of the wall contact sensing assemblies 6 includes a water wheel 62 rotatably arranged on the upper housing 1 and a Hall sensing probe 83 fixedly arranged on the lower housing 2. The Hall sensing probe 83 can detect the rotation state of the water wheel 62 to determine whether the swimming pool cleaning machine makes contact with the wall or not, and then send corresponding control signals to control different power units to operate, thus changing the traveling direction. The water wheel 62 includes a rotation portion 622 and blades 621 radially connected on the rotation portion 622. The end of the rotation portion 622 is connected with a rotation disk 623. A plurality of magnets are distributed and installed on the rotation disk 623 along the circumferential direction. When the parts, located in a wall contact detection water channel 16, of the blades 621 are impacted by the water flow (when the swimming pool cleaning machine travels, the water flow can pass through the wall contact detection water channel 16), the magnets rotate relative to the Hall sensing probe 83. At this time, the rotation of the water wheel 62 is detected, and the swimming pool cleaning machine is known to be in a travelling state. When the blades 621 are not acted upon by the water flow (when the swimming pool cleaning machine makes contact with the wall, the water flow does not pass through the wall contact detection water channel 16 any longer), the magnets are stationary relative to the Hall sensing probe 83. At this time, the water wheel 62 is detected to be stationary, and the swimming pool cleaning machine is known to be in a wall contact stagnant state. The Hall sensing probe 83 can detect a wall contact signal and send the wall contact signal to the controlling device, and the travelling direction is changed to get out of contact with the wall by operating different power units.

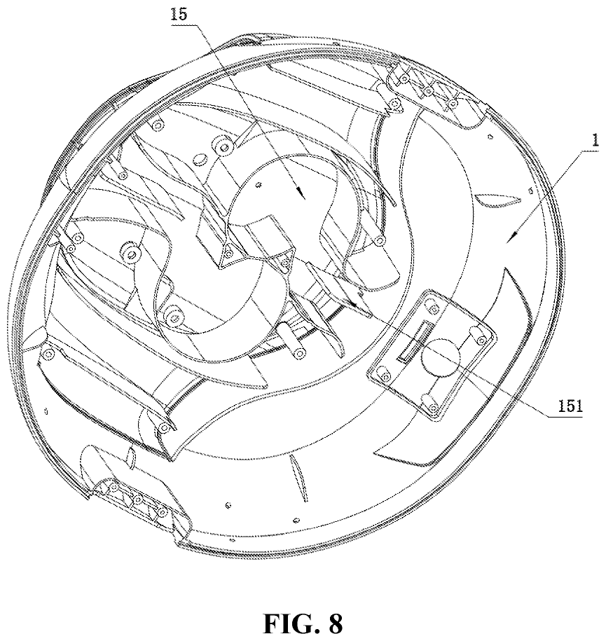

As shown in FIG. 8 and FIG. 9, a curved baffle structure for forming the water outlet channel 15 is provided inside the upper housing 1, the water outlet chamber is separated by a division plate 43, and the division plate 43 and the upper housing 1 are combined to form the water outlet channels 15. Protective grilles 41 are arranged at an inlet and outlet positions of the wall contact detection water channel 16 respectively, and the protective grilles 41 are used for protecting the water flow entering and exiting the wall contact detection water channel 16, so as to avoid interference on normal operation of the wall contact sensing assembly 6 caused by impurities entering the wall contact detection water channel 16, and the protective grilles 41 and the division plate 43 may be integrally molded as an integral grille plate 4 that is integrally installed, thus, the integrity of installation can be ensured, and the installation difficulty can be reduced.

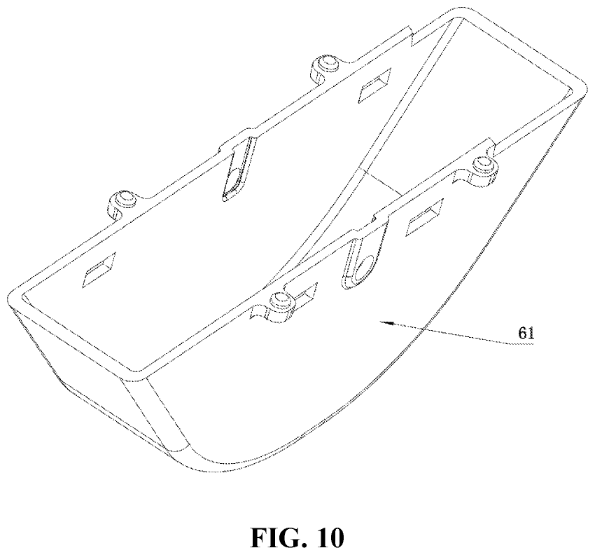

As shown in FIGS. 10-13, the swimming pool cleaning machine includes an arc-shaped groove 61. The low half part of the water wheel 62 is arranged in the arc-shaped groove 61, and the upper half part of the water wheel 62 is arranged in the wall contact detection water channel 16. The rotation of the water wheel 62 is only affected by the water flow in the wall contact detection water channel 16, so that the impact of the water flow in the water outlet chamber on the water wheel 62 can be eliminated under the normal working state of the impeller 5. When the swimming pool cleaning machine contacts the wall and then keep stationary, the magnets installed on the water wheel 62 can be stationary relative to the Hall sensing probe 83. A central shaft 63 is rotatably erected on the two side walls of the arc-shaped groove 61. The rotation portion 622 of the water wheel 62 rotatably sleeves on the sleeve 64, and the sleeve 64 rotatably sleeves on the central shaft 63, namely, the rotation portion 622 is rotatably connected with the sleeve 64 to form one-stage rotational connection, and the sleeve 64 is rotatably connected with the central shaft 63 to form one-stage rotational connection. Shaft shoulders are respectively arranged at both ends of the central shaft 63. The two shaft shoulders are rotatably clamped on the two side walls of the arc-shaped groove 61, namely, the central shaft 63 is rotatably connected with the arc-shaped groove 61 to form one-stage rotational connection. When one of the one-stage rotational connections is influenced by debris and then cannot rotate, the other of the one-stage rotational connections can be used to avoid the rotation of the water wheel 62 from being stuck and ensure the stable operation of the wall contact sensing assembly 6. In addition, the distance between the two shaft shoulders of the central shaft 63 is greater than the axial width of the water wheel 62, so that when the arc-shaped groove 61 is deformed and contracted, the two side walls of the arc-shaped groove 61 (it should be noted that the central shaft 63 may no longer rotate relative to the two side walls of the arc-shaped groove at this time) can be supported, thereby avoiding the influence of the two side walls of the arc-shaped groove 61 on the rotation of the water wheel 62, and further improving the operation reliability of the wall contact sensing assembly 6.

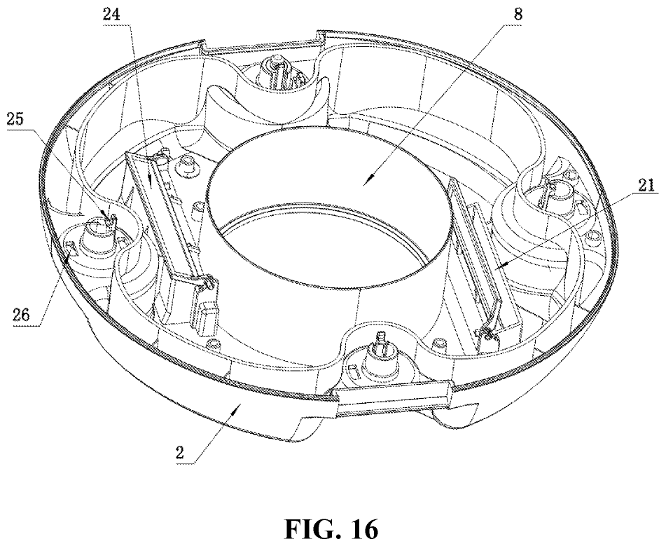

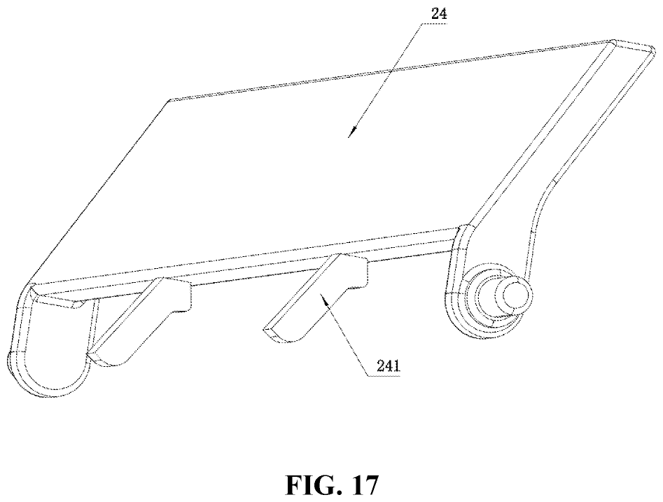

As shown in FIG. 16 and FIG. 17, a swing-in baffle 24 is hinged to the water inlet 21; when the impeller 5 operates, the water flow is drawn into the water inlet chamber; under the action of the water flow, the swing-in baffle 24 is flushed by the water flow so as to ensure that the water flow enters smoothly; and after the impeller 5 stops working, the swing-in baffle 24 seals the water inlet 21 by its own weight to avoid the leakage of dirt drawn into the water inlet chamber. The swing-in baffle 24 is connected to a limiting portion 241, and the limiting portion 241 is at a certain angle with the swing-in baffle 24. When the swing-in baffle 24 is opened, the limiting portion 241 can limit the swing angle of the swing-in baffle 24 less than 90 degrees. When there is not the impact of the water flow, the swing-in baffle 24 can seal the water inlet 21 by its own weight. By means of the arrangement of the swing-in baffle 24, when water is drawn, the water can smoothly enter the water inlet chamber via the water inlet 21, and the swing angle of the swing-in baffle 24 can be limited via the limiting portion 241, thereby avoiding the problem that the water inlet 21 cannot be sealed by its own weight due to the excessive swing angle thereof, and dirt which have been filtered in the water inlet chamber are discharged again, so that the smooth progress of the cleaning process can be ensured.

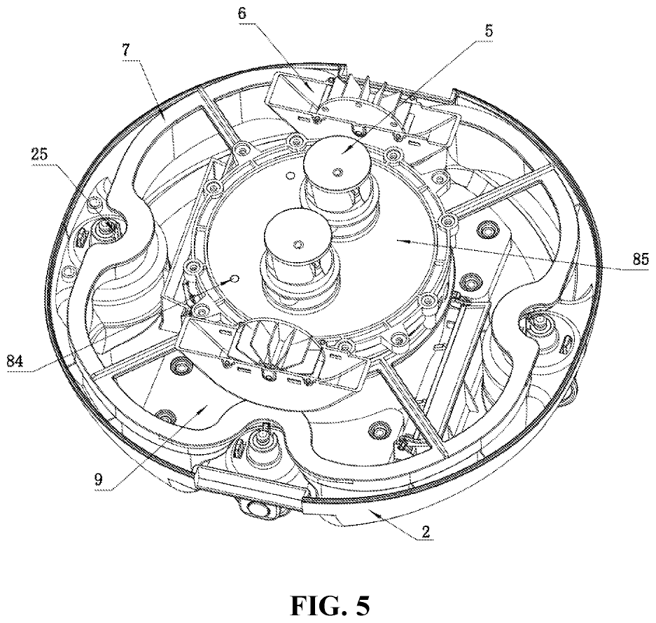

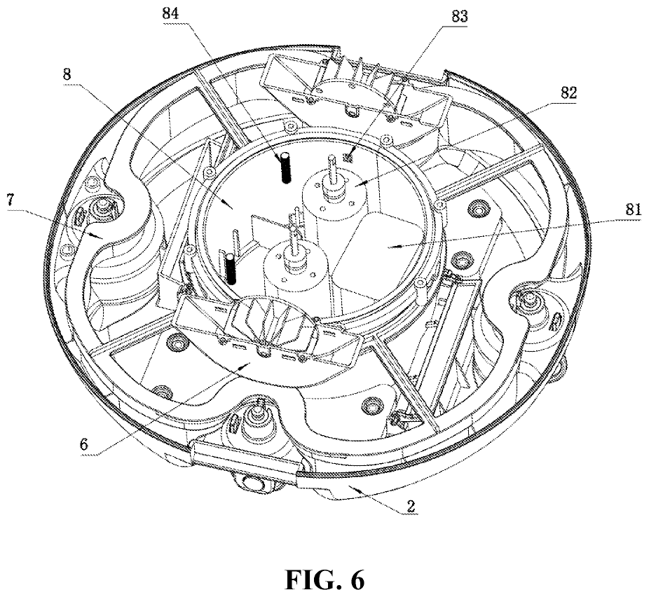

As shown in FIG. 5 and FIG. 6, a control cabin 8 is provided in the middle of the lower housing 2, and a battery 81 for supplying power is provided in the control cabin 8, the battery 81 is charged via a charging port 23 (as shown in FIG. 2) provided at the bottom of the lower housing 2, electric motors 82 for driving the impellers 5 to rotate and liquid level probes 84 for sensing the water level are also provided in the control cabin 8, a control cabin cover 85 is provided on the top of the control cabin 8, and the control cabin 8 is sealed and waterproof via the control cabin cover 85, the liquid level probes 84 extend out of the control cabin cover 85, and when the swimming pool cleaning machine is immersed in the water, the liquid level probe 84 detects a signal and then linkage controls the operation of the impellers 5. As shown in FIG. 1, an indicating light 12 and a switch 13 are provided outside the upper housing 1, and the indicating light 12 and the switch 13 communicate with the components inside the control cabin 8 by means of a circuit, so as to achieve the communication of power supply and control signals. As shown in FIG. 5 and FIG. 17, a second counterweight block 9 may also be provided in the lower housing 2 around the control cabin 8, the second counterweight block 9 is used for improving the overall weight of the swimming pool cleaning machine, so as to overcome the influence of the water buoyancy and the impact of the water flow, and ensure that the swimming pool cleaning machine moves smoothly at the bottom of the swimming pool to perform cleaning work.

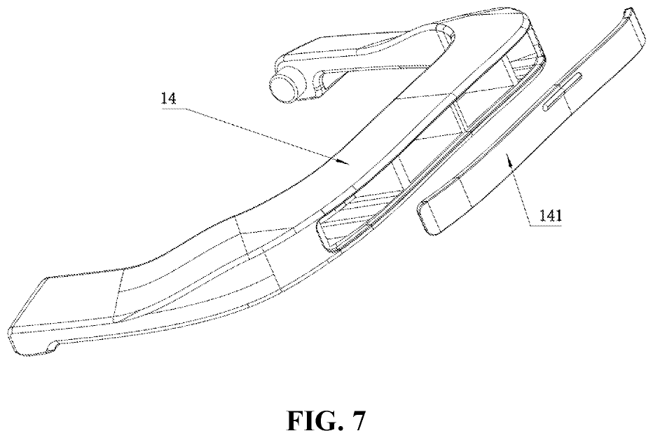

As shown in FIG. 7, a U-shaped handle 14 is provided on the top of the housing (the upper housing 1), two supporting legs of the U-shaped handle 14 are hinged on the upper housing 1, and the top of the U-shaped handle 14 is hollow and is sealed via a handle cover 141. The hollow part of the U-shaped handle 14 can be subjected to water buoyancy in water, so that the top of the U-shaped handle 14 can naturally float to be in a vertical state. When it is necessary to extract for charging or repairing, it is convenient to use a tool to clamp the U-shaped handle 14, so as to facilitate the grabbing of the swimming pool cleaning machine at the bottom of the swimming pool, thereby improving the convenience of operation.

The working process is as follows.

The switch 13 is turned on, the indicating light 12 shows normal operation, and a tool is used to place the swimming pool cleaning machine into the swimming pool via the U-shaped handle 14. The water in the swimming pool enters the interior of the swimming pool cleaning machine via the water inlet 21, the water outlet 42 and the like, and after a water signal is detected by the liquid level probe 84, the impeller 5 is controlled to operate. After the impeller 5 operates, the water enters the water inlet chamber via the water inlet 21, flows into the water outlet chamber after being filtered by the filter screen 7, enters the water outlet channel 15 via the outlet 52 of the impeller 5, and finally is discharged through the water outlet 42. The reaction force of the water flow discharged from the water outlet 42 provides the power for the swimming pool cleaning machine to travel, further, the swimming pool cleaning machine receives the steering thrust of the steering stressed portion 154, at this moment, the swimming pool cleaning machine travels to the left front or the right front, and after contacting the wall surface, the Hall sensing probe 83 in the wall contact sensing assembly 6 detects a corresponding signal, thus, the other power unit having an opposite driving direction is started to continue to run, and at this moment, the other impeller 5 is started to continue to run to drive the swimming pool cleaning machine to travel to the right front or the left front. After contacting the wall surface again, the power unit continues to be replaced for changing the direction of driving and travelling, repeat the process, the zigzag travelling route may be formed in the swimming pool to cover the bottom area of the swimming pool and clean the swimming pool relatively thoroughly. When the swimming pool cleaning machine is required to be charged or cleaned and repaired, the vertical U-shaped handle 14 in the water is hooked by means of a tool and then is taken out; the upper housing 1 and the lower housing 2 are separated by opening the second buckles 11 to clean the dirt therein; and charging is performed via the charging port 23 at the bottom of the lower housing.

Specific examples are used for illustration of the principles and implementation methods of the present disclosure. The description of the above-mentioned embodiments is used to help illustrate the method and its core principles of the present disclosure. In addition, those skilled in the art can make various modifications in terms of specific embodiments and scope of application in accordance with the teachings of the present disclosure. In conclusion, the content of this specification shall not be construed as a limitation to the present disclosure.

What is claimed is:

1. A power unit used for a swimming pool cleaning machine, comprising an impeller and a water outlet channel horizontally arranged and communicated with the impeller, wherein the water outlet channel comprises a spiral portion, a linear flowing portion and a water outlet which are communicated to one another in sequence, an inlet of the impeller is communicated with water, an outlet of the impeller is communicated with the spiral portion, the linear flowing portion deflects to the outer side of a spiral direction of the spiral portion, a steering stressed portion is formed at a junction of the linear flowing portion and the spiral portion, the steering stressed portion and the spiral portion are respectively located on both sides of a center line of the water outlet, and a water outlet direction of the water outlet is opposite to a traveling direction of the swimming pool cleaning machine.

2. The power unit used for a swimming pool cleaning machine according to claim 1, wherein a flow distribution plate is arranged in the linear flowing portion in a direction parallel to an extending direction of the linear flowing portion, the water outlet is of a flared structure, an swing-out baffle is hinged to the water outlet at an upper part of the swing-out baffle, and the swing-out baffle seals the water outlet by its own weight when it is not subjected to an impact of a water flow.

3. A swimming pool cleaning machine, comprising a housing, a travelling device arranged at a bottom of the housing and a filter screen arranged inside the housing, wherein the filter screen divides a space inside the housing into a water inlet chamber and a water outlet chamber, the water inlet chamber is in communication with water inlets at the bottom of the housing, the water outlet chamber is in communication with two groups of power units according to claim 1 with opposite driving directions, the inlet of the impeller is communicated with the water inside the water outlet chamber, the water outlet is in communication with an outside of the housing and the water outlet direction of the water outlet is opposite to the traveling direction of the traveling device; one of the water inlets is located on a right side of the travelling device with respect to the traveling direction of the travelling device, and the steering stressed portion is subjected to a counterclockwise deflecting force, or one of the water inlets is located on a left side of the travelling device with respect to the traveling direction of the travelling device, and the steering stressed portion is subjected to a clockwise deflecting force.

4. The swimming pool cleaning machine according to claim 3, wherein the travelling device comprises travelling wheels, each of the travelling wheels is rotatably installed on a wheel frame via a wheel shaft, a top of the wheel frame is provided with a positioning block and an annular groove, a positioning groove is arranged at a position on the housing corresponding to the positioning block, a first buckle is arranged corresponding to the annular groove, and the first buckle is clamped into the annular groove to fix the wheel frame; the wheel frame is provided with a large through-hole and a small through-hole for being penetrated by the wheel frame, the wheel shaft comprises a small diameter portion and a large diameter portion connected to each other, the small diameter portion has a diameter smaller than that of the small through-hole, and the large diameter portion has a diameter between the diameter of the small through-hole and a diameter of the large through-hole.

5. The swimming pool cleaning machine according to claim 4, wherein the travelling wheels are disposed on an outer surface of a bottom of the housing in a cross-shaped arrangement, and a gravity center of one of the travelling wheels at a front side and a gravity center of one of the travelling wheels at a rear side are provided in an offset arrangement, and are offset towards respective water inlets.

6. The swimming pool cleaning machine according to claim 3, wherein the housing is provided with wall contact sensing assemblies, wherein each of the wall contact sensing assemblies comprises a water wheel rotatably arranged on the housing and a Hall sensing probe fixedly arranged on the housing, the water wheel comprises a rotation portion and blades radially connected on the rotation portion, an end of the rotation portion is connected with a rotation disk, a plurality of magnets are distributed and installed on the rotation disk along a circumferential direction, when parts, located in a wall contact detection water channel, of the blades are impacted by a water flow, the magnets rotates relative to the Hall sensing probe, and when the blades are not acted upon by the water flow, the magnets are stationary relative to the Hall sensing probe.

7. The swimming pool cleaning machine according to claim 6, comprising arc-shaped grooves, wherein a central shaft is rotatably erected on two side walls of each of the arc-shaped grooves, the rotation portion is rotatably sleeved on the central shaft, two ends of the central shaft are respectively arranged with two shaft shoulders, the two shaft shoulders are rotatably clamped on the two side walls of a corresponding one of the arc-shaped grooves, and a distance between the two shaft shoulders is greater than an axial width of the water wheel.

8. The swimming pool cleaning machine according to claim 7, wherein a sleeve is rotatably arranged in the rotation portion, and the central shaft is rotatably arranged in the sleeve.

9. The swimming pool cleaning machine according to claim 3, wherein each of the water inlets is hinged to a swing-in baffle, the swing-in baffle is connected to a limiting portion, a swing angle of the swing-in baffle is limited by the limiting portion to less than 90 degrees, and the swing-in baffle seals a corresponding one of the water inlets by its own weight when it is not subjected to an impact of a water flow.

10. The swimming pool cleaning machine according to claim 3, wherein a top of the housing is provided with a U-shaped handle, two supporting legs of the U-shaped handle are hinged on the housing, and a top of the U-shaped handle is hollow and is sealed by a handle cover.

11. The swimming pool cleaning machine according to claim 3, wherein a flow distribution plate is arranged in the linear flowing portion in a direction parallel to an extending direction of the linear flowing portion, the water outlet is of a flared structure, an swing-out baffle is hinged to the water outlet at an upper part of the swing-out baffle, and the swing-out baffle seals the water outlet by its own weight when it is not subjected to an impact of a water flow.

12. The swimming pool cleaning machine according to claim 11, wherein the housing is provided with wall contact sensing assemblies, wherein each of the wall contact sensing assemblies comprises a water wheel rotatably arranged on the housing and a Hall sensing probe fixedly arranged on the housing, the water wheel comprises a rotation portion and blades radially connected on the rotation portion, an end of the rotation portion is connected with a rotation disk, a plurality of magnets are distributed and installed on the rotation disk along a circumferential direction, when parts, located in a wall contact detection water channel, of the blades are impacted by a water flow, the magnets rotates relative to the Hall sensing probe, and when the blades are not acted upon by the water flow, the magnets are stationary relative to the Hall sensing probe.

13. The swimming pool cleaning machine according to claim 4, wherein the housing is provided with wall contact sensing assemblies, wherein each of the wall contact sensing assemblies comprises a water wheel rotatably arranged on the housing and a Hall sensing probe fixedly arranged on the housing, the water wheel comprises a rotation portion and blades radially connected on the rotation portion, an end of the rotation portion is connected with a rotation disk, a plurality of magnets are distributed and installed on the rotation disk along a circumferential direction, when parts, located in a wall contact detection water channel, of the blades are impacted by a water flow, the magnets rotates relative to the Hall sensing probe, and when the blades are not acted upon by the water flow, the magnets are stationary relative to the Hall sensing probe.

14. The swimming pool cleaning machine according to claim 5, wherein the housing is provided with wall contact sensing assemblies, wherein each of the wall contact sensing assemblies comprises a water wheel rotatably arranged on the housing and a Hall sensing probe fixedly arranged on the housing, the water wheel comprises a rotation portion and blades radially connected on the rotation portion, an end of the rotation portion is connected with a rotation disk, a plurality of magnets are distributed and installed on the rotation disk along a circumferential direction, when parts, located in a wall contact detection water channel, of the blades are impacted by a water flow, the magnets rotates relative to the Hall sensing probe, and when the blades are not acted upon by the water flow, the magnets are stationary relative to the Hall sensing probe.
